(19) United States
(12) Patent Application Publication
(10) Pub. No.: US 2016/0246995 A1
(43) Pub. Date: Aug. 25, 2016

(54) METHOD AND APPARATUS FOR AUTHORIZED ACCESS TO LOCAL FILES ON A COPY APPLIANCE

(71) Applicant: BARRACUDA NETWORKS, INC., Campbell, CA (US)

(72) Inventors: Jason D. Dictos, Ypsilanti, MI (US); Andy Blyler, Ann Arbor, MI (US)

(21) Appl. No.: 15/017,490

(22) Filed: Feb. 5, 2016

Related U.S. Application Data
(60) Provisional application No. 62/120,756, filed on Feb. 25, 2015.

(51) Int. Cl. G06F 21/62; H04L 29/06

(52) U.S. Cl. CPC G06F 21/6245; H04L 63/0272; H04L 63/102

(57) ABSTRACT

A new approach is proposed that contemplates systems and methods to support authorized access by a second client to files stored on a local content appliances (CA), wherein each content appliance is a storage device/host configured to locally maintain entire or parts of files owned and maintained by a first user. First, a first client agent is configured to establish a region including at least one local CA and to provide authoritative copies of one or more of its files and/or their parts containing sensitive information of the first client to be stored and maintained on the CA in the region instead of uploading them to a cloud storage. The first client agent uploads only metadata of the files to the cloud storage wherein the metadata includes information on storage location and access permission of the files and/or their parts. A second client agent is configured to retrieve the metadata of the files from the cloud storage and to request access to the authoritative copies of the files and/or their parts directly from the local CA in the region based on the retrieved metadata.

### CROSS-REFERENCE TO RELATED APPLICATIONS

This application claims the benefit of U.S. Provisional Patent Application No. 62/120,756, filed Feb. 25, 2015, and entitled “Local authoritative part access storage on copy appliance,” which is incorporated herein in its entirety by reference.

This application is related to co-pending U.S. patent application Ser. No. 15/012,663, filed Feb. 1, 2016, and entitled “Method and apparatus for client to content appliance (CA) synchronization,” which is incorporated herein in its entirety by reference.

### BACKGROUND

For a long time the typical synchronization or sync and share application was defined as a system that is configured to download and upload files automatically to a client at a local computer host such as a desktop or a laptop computing device/machines. With more and more data being stored in a cloud storage these days, local storage allowances become an issue and some of the sync and share applications started to provide methods that provide users control over what files are to be downloaded to or uploaded from their local machines/systems to the cloud storage.

For corporations have a large amount of storage needs for data and files, accessing the files maintained in the cloud may impose a severe burden on the communication bandwidth between its local hosts and the cloud storage. The network traffic jam may be further exacerbated if the network connections at the local hosts are not always at the highest quality, causing severe delay for the users/clients at the local hosts to access their files that are not stored/cached locally on the local hosts. In addition, certain files of a company/client may contain sensitive data/information of the company, which the company may prefer to maintain the authoritative copies of the files locally instead of uploading them to the cloud storage. Such local maintenance of the files containing sensitive data would provide the company the benefit of knowing that their sensitive data is always under their control. Still, it is desirable to allow remote access to the locally-stored authoritative copies of the files as if they were uploaded to the cloud storage at least for those (other) clients having access permission to the files.

It is thus desirable to provide a file synchronization approach for the local client that overcomes the limitations of the current designs and provides the users with instant access to all their files without requiring the files to be stored locally.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support access to authorized copies of files on a local copy appliance (CA) in accordance with some embodiments.

FIG. 2 depicts an example of organizing files into shares with access restrictions in accordance with some embodiments.

FIG. 3 depicts a non-limiting example of allocation of shares to different regions of the first user in accordance with some embodiments.

FIG. 4 depicts a flowchart of an example of a process to support access to authorized copies of files on a local copy appliance (CA) in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support authorized access by a second client to files stored on a local content appliances (CA), wherein each content appliance is a storage device/host configured to locally maintain entire or parts of files owned and maintained by a first user. First, a first client agent at a local host of a first user/client/company is configured to establish a region including at least one local CA that manages its files locally and to provide authoritative copies of one or more of its files and/or their parts containing sensitive information of the first client to be stored and maintained on the CA in the region instead of uploading them to a cloud storage. The first client agent then uploads only metadata of the files to the cloud storage wherein the metadata includes information on storage location and access permission of the files and/or their parts. A second client agent at a local host of a second user is configured to retrieve the metadata of the files from the cloud storage and to request access to the authoritative copies of the files and/or their parts directly from the local CA in the region based on the retrieved metadata. The second client agent is allowed or denied access to the files and/or their parts from the local CA in the region according to access permission and/or access restriction (e.g., read-only access) to the files specified by the first client agent.

By establishing a storage region that includes one or more local CAs separate from the cloud storage, the proposed approach enables a client to organize its files in such a way that certain files (or parts of them) are stored on a local CA while the rest of its files are stored on the cloud storage. Under such storage arrangement, the client can own and host its sensitive data on the local CA in its specified region for security reasons while still allowing authorized access to the files and/or its parts stored on the local CA by another client under access permission and restriction. Additionally, since the other client may leverage peer-to-peer connection in a local area network (LAN) when accessing the files and/or its parts on the local CA instead of downloading them from the cloud storage, the files and/or its parts can be retrieved efficiently from the local CA at high throughput/speed.

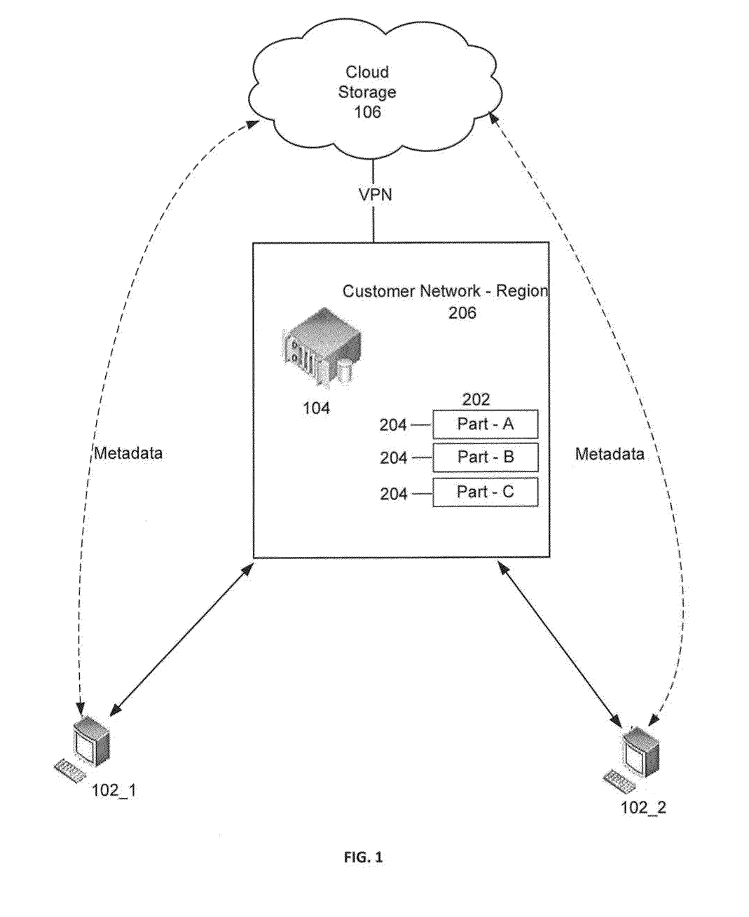

FIG. 1 depicts an example of a system diagram 100 to support access to authorized copies of files on a local copy appliance (CA). Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes one or more of client agents 102 running on one or more local machines/computing units/hosts, a content appliance (CA) 104, and a cloud storage 106. Here, each local host can be a computing device, a communication device, a storage device, or any electronic device capable of running a software component. For non-limiting examples, a computing device can be but is not limited to a laptop PC, a desktop PC, an iPod, an iPhone, an iPad, a Google's Android device, or a server/host/machine. A storage device can be but is not limited to a hard disk drive, a flash memory drive, or any portable storage device.

In the example of FIG. 1, the components of system 100 are configured to communicate with each other following certain communication protocols, such as TCP/IP protocol, over one or more communication networks. Here, the communication networks can be but are not limited to, Internet, intranet, wide area network (WAN), local area network (LAN), wireless network, Bluetooth, WiFi, and mobile communication network. The physical connections of the network and the communication protocols are well known to those of skill in the art. The forms of information being communicated among the various parties listed above over the communication networks includes but is not limited to, emails, messages, web pages with optionally embedded objects (e.g., links to approve or deny the request).

In the example of FIG. 1, the system 100 adopts a multi-tiered hybrid storage mechanism that includes storage space on the lost host, the CA 104, and the cloud storage 106. Here, the CA 104 includes one or more local storage devices/servers dedicated to store and manage large-scale data and files of the first user but is physically separated from the local host of the first client agent 102_1. The storage devices of the CA 104, available as a physical or virtual appliance, can be either onsite with the local host in the same internal local area network (LAN) or offsite on the Internet. The CA 104 is configured to communicate with the cloud storage 106 via a virtual private network (VPN) to optimize access, performance and security for local and cloud-based file synchronization and sharing. In some embodiments, the CA 104 is configured to support local recovery for the first client agent 102_1 to access its files even in the event of an external network outage when the access to the cloud storage 106 is not available. In some embodiments, the CA 104 functions as a “never full” cache for the first client agent 102_1 by caching the most frequently used files locally as discussed in details later.

In the example of FIG. 1, the cloud storage 106 in FIG. 1 includes a plurality of servers and/or CAs 104 configured to manage and store the files for the client agents 102 remotely in the cloud (on the Internet) at geographically distributed locations different from the locations of the local host of the client agents 102 and the CA 104. In some embodiments, the cloud storage 106 further maintains information (such as the metadata) of the files stored on the CA 104 or the cloud storage 106.

In some embodiments, each file 202 under the multi-tiered hybrid storage mechanism can have only one authoritative and most up-to-date copy, which can be either centrally maintained at the cloud storage 106 or only at the CA 104 if such file includes sensitive data which the client would prefer to maintain locally under its control. Regardless of the storage location of authoritative copies of the file 202, its metadata can be stored separately from the file 202 at a different location.

As shown in the example of FIG. 1, each file 202 may include one or more parts 204 at appropriate offsets that together represent the complete file. Each part 204 is a chunk of data that can be variable in size and can be represented by a unique identifying hash value (e.g., MD5-SHA1-SIZE) as its part key. When a file 202 is requested and accessed by a client agent 102 (e.g., the second client agent 102_2), the entire file or one or more parts of it stored on the CA 104 or the cloud storage 106 is provided to the client agent 102 under access permission and restriction as discussed below. No two similar parts of the authoritative copy of the file 202 are redundantly stored on the CA 104 or the cloud storage 106 so that all files under the multi-tiered hybrid storage mechanism are de-duplicated.

In some embodiments, every part 204 of the file 202 being accessed may have a reference count, indicating how many users are accessing it via their respective client agents 102. A part is removed from the CA 104 or the cloud storage 106 when its reference count goes to zero, indicating that the part is no longer accessed by the client agents 102. In some embodiments, each file 202 may further include metadata of the file, which describes the current state of the file, e.g., size, time of creation, version, status (modified or not), storage location, and action to be taken on the file, and can be stored separately from the file 202 at different locations.

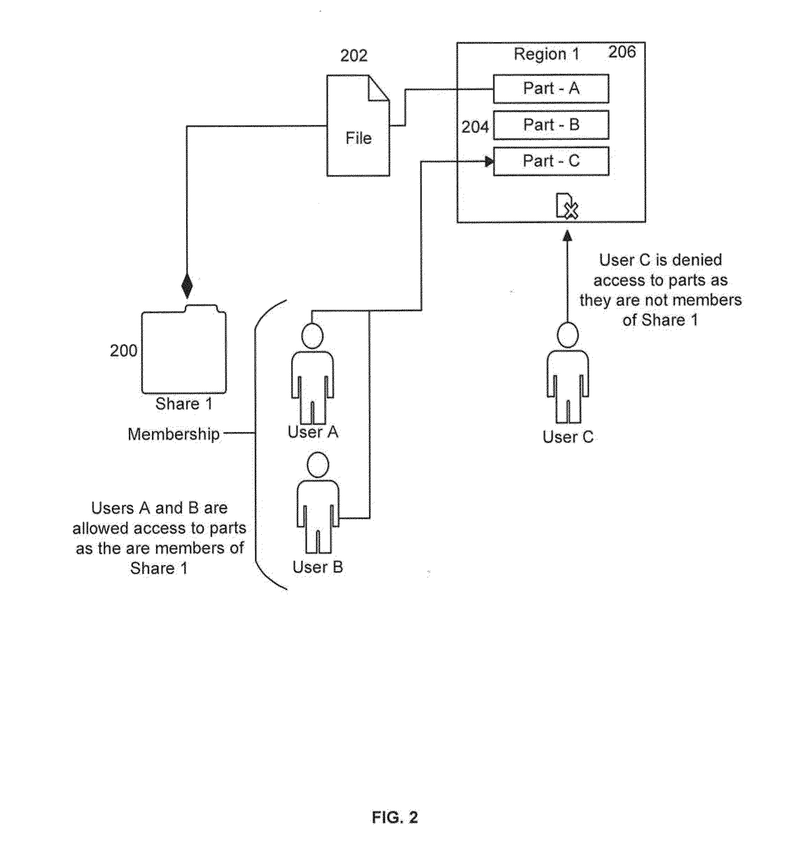

In some embodiments, files 202 are organized and stored in a plurality of shares 200, wherein each share 200 is configured to allow only its member users to access the files 202 and/or their parts 204 in the share 200. As shown by the example of FIG. 2, Users A and B are both members of Share 1 and are allowed to access files 202 and/or their parts 204 in Share 1 via their associated client agents 102. User C, on the other hand, is denied access to the files 202 and/or their parts 204 in Share 1 because it is not a member of Share 1.

In some embodiments, the first client agent 102_1 associated with a first user is configured to designate and establish its own region 206 including one or more storage devices such as the CA 104, wherein the CA 104 stores and maintains a plurality of files and/or their parts of the first user. Here, the region 206 is dedicated to store and maintain authoritative copies of files and/or parts of the first user, wherein any other users can only access the files and/or the parts with access permission and restriction of the first user. In some embodiments, the first client agent 102_1 is configured to designate a plurality of its own regions 206 to serve access requests to the files in the regions from different types of users. For a non-limiting example, the first client agent 102_1 may designate a plurality of regions 206 at various geographical locations around the world (e.g., a US region, an European region, and an Asian region) so that a user may access one of the regions 206 that is closest to its geographical location.

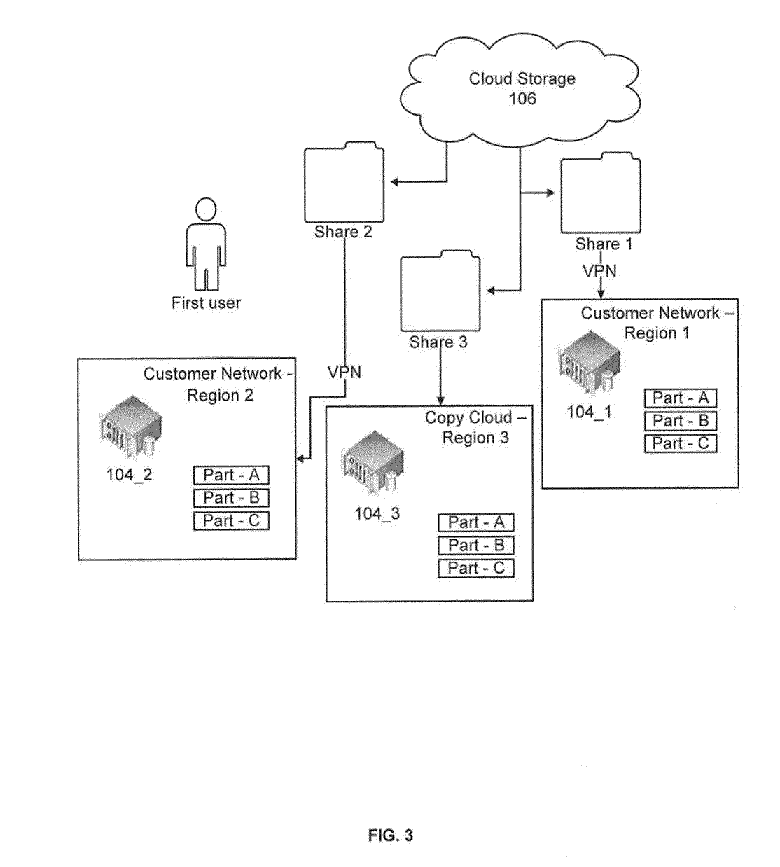

In some embodiments, the CA 104 of a region 206 of the first user can be located either locally within the same LAN of the local host of the first client agent 102_1 or in the cloud as part of the cloud storage 106. In some embodiments, the first user may specify via the first client agent 102_1 where each of its shares 200 should reside. For example, some shares 200 of the first user are designated to a region 206 residing locally in the same LAN as the local host of the first user since the client would like to have these shares 200 having sensitive information under its control. For another example, some other shares 200 of the first user are designated to a region 206 in the cloud (e.g., as part of the cloud storage 106) for low latency fast access by other users. FIG. 3 depicts a non-limiting example of allocation of shares 200 to different regions 206 of the first user. As shown in FIG. 3, files and parts in Shares 1 and Share 2 are locally stored and maintained on CAs 104_1 and 104_2 in Regions 1 and 2, respectively, which are within the internal networks of the first user. Files and parts in Share 3, on the other hand, are stored in the cloud on CA 104_3 in Region 3, which is part of the cloud storage 106. Under such configuration, another user requesting files and/or parts in Share 1 or 2 would access them from Regions 1 and 2, respectively, wherein the files and/or parts are only stored locally on the CAs 104_1 and 104_2, respectively. A user requesting files and/or parts in Share 3, on the other hand, may access them directly from Region 3 in the cloud. do not have the files and/or the parts locally) via VPN between the regions and the cloud storage 106.

In the example of FIG. 1, the first client agent 102_1 is a software program/application running on a first user's local host, wherein the first client agent 102_1 is configured to store and maintain files of the first user and their metadata at separate storage locations from the local host. In some embodiments, the first client agent 102_1 is configured to first upload the metadata of the files and/its parts to be stored separately from the local host to the cloud storage 106. The first client agent 102_1 then identifies the IP address of a CA 104 in one of its regions 206 on which the files and/its parts are to be stored. Here, the IP address of the CA 104 reflects the location of the CA 104, which is separate from the cloud storage 106 as the first user prefers to have the files and/its parts that may contain its sensitive data to be under its control and not uploaded to the cloud storage 106. The IP address can be either an internal IP address if the CA 104 is located within the same internal network (or intranet) as the local host of the first client agent 102_1 behind a firewall or at a public IP address accessible by the first client agent 102_1 over a network. In some embodiments, the first client agent 102_1 may request and receive the IP address of the CA 104 from the cloud storage 106.

Once the IP address of the CA 104 is identified, the first client agent 102_1 attempts to establish a connection with the CA 104 at the provided IP address directly. In some embodiments, the connection with the CA 104 is a secured connection where all data transmitted over the secured connection is encrypted if the CA 104 is located on a public network outside of the firewall of the internal network of the first client agent 102_1. In some embodiments, the cloud storage 106 is configured to broker an authentication token with the first client agent 102_1 and the CA 104, wherein the authentication token can be used to authenticate both the first client agent 102_1 and the CA 104 before either of the end points allows data traffic (files and/or their parts) to be transmitted over the connection. Here, the cloud storage 106 is configured to communicate with the CA 104 via a VPN tunnel for secured communication (e.g., exchange of user information) between them.

In some embodiments, the CA 104 is configured to serve more than one client agents 102s running on different local hosts by establishing separate secured connections with the client agents 102s. In some embodiments, the CA 104 is configured to keep the authoritative copies of files belonging to different client agents 102s separately in their respective shares 200 and/or regions 206 so that one client agent may not access files in another share and/or region that belong to another client agent without access permission by that client agent. In some embodiments, where the files owned by different client agents 102s overlap, meaning one file is owned by both of them at the same time, the CA 104 is configured to maintain only one authoritative copy of the file and its parts to be shared by both client agents to avoid any potential duplication.

Once the secured connection between the first client agent 102_1 and the CA 104 has been established and both parties have been authenticated, the first client agent 102_1 is configured to transmit and store files and/or their parts in one or more shares 200 on the CA 104 in region 206, wherein access to the files and/or their parts within the region 206 is subject to access permission and restriction defined and controlled by the first client agent 102_1 due to sensitivity of the files. In some embodiments, the first client agent 102_1 is configured to define the access permission and restriction on either per-share basis or per-region basis, wherein each share 200 and/or its region 206 has a user access list associated with it, which includes a plurality of users and their access permissions in the form of (user, access permission). Here, the access permission can be but is not limited to read only or read/write to each file and part in the respective share 200 or region 206.

When a second user attempts to access a file 202 (or part of it) for a read or write operation, a second client agent 102_2 running on a local host associated with the second user is configured to first request for and receive metadata of the file from the cloud storage 106, which maintains the up-to-date version of the metadata of the files regardless where the files are stored. Here, the metadata of the file requested includes various information of the file as discussed above, including the storage location of the authoritative copy of the file and/or its parts (e.g., either in the cloud or on a local CA). If the authoritative copy of the file and/or its parts are stored in shares and regions in the cloud, the second client agent 102_2 is configured to retrieve the parts or the file from the cloud storage 106 directly. If the authoritative copy of the file and/or its parts are on the CA 104 in region 206 according to the retrieved metadata, the second client agent 10_2 is configured to request the file and/or its parts from the CA 104 instead of from the cloud storage 106.

Upon receiving the request for the file and/or its parts from the second client agent 102_2, the CA 104 is configured to check the access permission of the share 200 and/or the region 206 in which the file and its parts reside. If the second user is on the access list and is allowed to access the file and its parts, the CA 104 is configured to provide the authoritative copy of the file and/or its parts to the second client agent 102_2. If the second user is not on the access list, the request to access the file and/or its parts is denied. In some embodiments, the second client agent 102_2 may submit an access request to the first client agent 102_1 directly so that the second user may be included in the access list of the share 200 and/or the region 206 that includes the file the second user would like to request. In some embodiments, the access request is submitted to the cloud storage 106, which would then broker an authentication session so that the second client agent 102_2 can be authenticated by the first client agent 102_1 and be added to the access list of the share 200 and/or region 206 of tis requested file.

After the second client agent 102_2 has obtained a copy of the file and/or its parts, it may proceed to perform a read or write operation on the file and/or its parts. To ensure that the CA 104 has the most up-to-date authoritative copy of the file and/or its parts, in some embodiments, the CA 104 is configured to adopt a locking mechanism as follows:
If the second user only has “read only” access permission to the file and/or the second client agent 102_2 is only performing a read operation on the file and/or its parts, the authoritative copy of the file and/or its parts on the CA 104 does not need to be locked, meaning that the file and/or its parts can also be accessed by other client agents having access permissions to the file.
If the second user has read/write access permission to the file and performs a write operation to the file and/or its parts via the second client agent 102_2, one or more parts of the file may be revised or modified. Under such scenario, the authoritative copy of the file and/or its parts on the local CA 104 is locked, meaning all other users may only have read access permission to the file regardless of their actual access permission on the access list. No update to the files and/or its parts is accepted before the second client agent 102_2 is finished updating and uploading the revised file and its parts to the CA 104. The metadata of the file maintained on the cloud storage 106 may also be locked.

In some embodiments, the second client agent 102_2 is configured to create one or more events representing changes made to the file and/or its parts during the write operation, wherein the changes need to be synchronized and updated to the authoritative copy of the file in the CA 104. In some embodiments, the second client agent 102_2 is configured to transmit the events, and all parts of the file that have been revised to the CA 104. Once the CA 104 acknowledges the receipt of the parts of the file, the second user at the second client agent 102_2 regards the changes to the file have been fully committed and synchronized to the CA 104 as the new authoritative copy of the file. In some embodiments, the CA 104 is configured to perform de-duplication operation of the parts of the file so that only one authoritative copy of the file and/or its part are kept in the corresponding share 200 and/or region 206 on the CA 104. In the meantime, the second client agent 102_2 is configured to update and upload revised metadata of the file to the cloud storage 106 in the background by processing the events and entries created by the second client agent 102_2 during the write operation, wherein the metadata reflects the latest changes made to the file and/or its parts. In some embodiments, the cloud storage 106 is configured to send an acknowledgment to the CA 104 and/or the second client agent 102_2 once the metadata of the file have been synchronized to the cloud storage 106. If the second user makes further modification to the parts of the file after the initial events or entries have been created but before the previous changes have been synchronized to the CA 104, new events and entries may be created by the second client agent 102_2 to reflect the latest changes to the file, wherein the new events are processed and synchronized to the CA 104 (and the metadata to the cloud storage 106).

After the revised file and/or its parts has been uploaded and authorized as the new authoritative copy of the file, the CA 104 is configured to notify all other client agents accessing the same file that the file and/or its parts have been updated and a new metadata is available. The other client agents may then request the new metadata from the cloud storage 106 and the updated parts of the file that have changed from the CA 104. By “playing back”/synchronizing the changes in the order that they occurred, the client agents guarantee that their local versions of the file are in sync with and accurately reflect the current state of the authoritative copy of the file maintained in the CA 104.

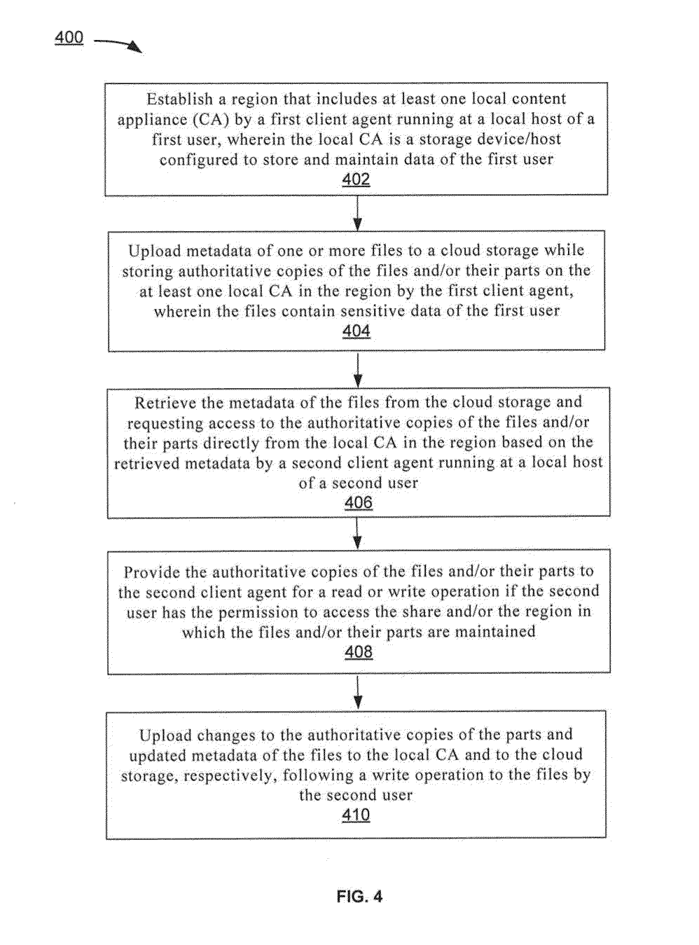

FIG. 4 depicts a flowchart 400 of an example of a process to support access to authorized copies of files on a local copy appliance (CA). Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 4, the flowchart 400 starts at block 402, where a region that includes at least one local content appliance (CA) is established by a first client agent running at a local host of a first user, wherein the local CA is a storage device/host configured to store and maintain data of the first user. The flowchart 400 continues to block 404, where metadata of one or more files are uploaded to a cloud storage while authoritative copies of the files and/or their parts are stored on the at least one local CA in the region by the first client agent, wherein the files contain sensitive data of the first user. The flowchart 400 continues to block 406, where the metadata of the files are retrieved from the cloud storage and the authoritative copies of the files and/or their parts are requested directly from the local CA in the region based on the retrieved metadata by a second client agent running at a local host of a second user. The flowchart 400 continues to block 408, where the authoritative copies of the files and/or their parts are provided to the second client agent for a read or write operation if the second user has the permission to access the share and/or the region in which the files and/or their parts are maintained. The flowchart 400 ends at block 410 where changes to the authoritative copies of the parts and the metadata of the files are uploaded to the local CA and to the cloud storage, respectively, following a write operation to the files by the second user.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support access to authorized local copies of files, comprising:
a first client agent running on a local host of a first user configured to
establish a region that includes at least one local content appliance (CA) a first client agent running at a local host of a first user, wherein the local CA is a storage device/host configured to store and maintain data of the first user;
upload metadata of one or more files to a cloud storage while storing authoritative copies of the files and/or their parts on the at least one local CA in the region by the first client agent, wherein the files contain sensitive data of the first user;
said at least one CA in the region configured to provide the authoritative copies of the files and/or their parts to a second client agent for a read or write operation if a second user of the second client agent has the permission to access the share and/or the region in which the files and/or their parts are maintained;
said second client agent running on a local host of said second user configured to
retrieve the metadata of the files from the cloud storage and request access to the authoritative copies of the files and/or their parts directly from the local CA in the region based on the retrieved metadata;
upload changes to the authoritative copies of the parts and updated metadata of the files to the local CA and to the cloud storage, respectively, following a write operation to the files by the second user.

2. The system of claim 1, wherein:
the metadata of the files includes storage locations of the authoritative copies of the file and/or its parts.

3. The system of claim 1, wherein:
the first client agent is configured to maintain the authoritative copies of the files and/or their parts of the files and/or their parts only on the local CA in the region.

4. The system of claim 1, wherein:
the CA includes one or more local storage devices/servers physically separate from the local host of the first client agent.

5. The system of claim 1, wherein:
the CA is available as a physical or virtual appliance and is either onsite in a same internal network with the local host or offsite on Internet.

6. The system of claim 1, wherein:
the CA is configured to communicate with the cloud storage via a virtual private network (VPN) to optimize access, performance and security for local and cloud-based file synchronization and sharing.

7. The system of claim 1, wherein:
each of the file includes one or more parts at appropriate offsets that together represent the complete file, wherein each part is a chunk of data that can be variable in size and represented by a unique identifying hash value as its part key.

8. The system of claim 7, wherein:
every part of the file being accessed has a reference count, indicating how many users are accessing it via their respective client agents, and a part is removed from the local host and/or the CA when its reference count goes to zero, indicating that the part is no longer accessed by the client agents and has been synchronized to the cloud storage by the CA.

9. The system of claim 1, wherein:
the first client agent is configured to designate and establish a plurality of its own regions to serve access requests to the files in the regions from different types of users.

10. The system of claim 1, wherein:
the first client agent is configured to identify an IP address of the CA in the region on which the files and/its parts are to be stored, wherein the IP address is either an internal IP address if the CA is located within the same internal network as the local host of the first client agent behind a firewall or at a public IP address accessible by the first client agent over a network.

11. The system of claim 10, wherein:
the first client agent is configured to establish a secured connection with the CA at the IP address directly, where all data transmitted over the secured connection is encrypted if the CA is located on a public network outside of the firewall of the internal network of the first client agent.

12. The system of claim 1, wherein:
the CA is configured to serve multiple client agents running on different local hosts by establishing separate secured connections with the client agents.

13. The system of claim 12, wherein:
the CA is configured to keep the authoritative copies of files belonging to different client agents separately in their respective shares and/or regions so that one client agent may not access files in another share and/or region that belong to another client agent without access permission by that client agent.

14. The system of claim 1, wherein:
the files are organized and stored in a plurality of shares in the region, wherein each share is configured to allow only its member users to access the files and/or their parts in the share.

15. The system of claim 14, wherein:
the first client agent is configured to specify where each of the shares and the region should reside, either on the local CA or the cloud storage.

16. The system of claim 14, wherein:
the first client agent is configured to define the access permission and restriction on either per-share basis or per-region basis, wherein each share and/or its region has a user access list associated with it, which includes a plurality of users and their access permissions in the form of (user, access permission).

17. The system of claim 16, wherein:
the second client agent is configured to submit an access request to the first client agent directly so that the second user is included in the access list of the share and/or the region that contains the files the second user requests.

18. The system of claim 1, wherein:
the CA is configured to lock the authoritative copies of the files and/or their parts when the write operation is performed to the file and/or its parts via the second client agent and one or more parts of the file are revised or modified, where Under such scenario, on the CA is locked, meaning no update to the files and/or its parts is accepted before the second client agent is finished updating and uploading the revised file and its parts to the CA.

19. The system of claim 1, wherein:
the second client agent is configured to create one or more events representing the changes made to the files and/or their parts during the write operation, wherein the changes are synchronized and updated to the authoritative copies of the files in the CA.

20. The system of claim 1, wherein:
the second client agent is configured to upload updated metadata of the files to the cloud storage after the write operation, wherein the metadata reflects the latest changes made to the files and/or their parts.

21. The system of claim 1, wherein:
the CA is configured to notify all other client agents accessing the files that the files and/or their parts have been updated and the updated metadata is available after the changes to the files and/or their parts have been uploaded and authorized as the new authoritative copies of the files.

22. A computer-implemented method to support access to authorized local copies of files, comprising:
establishing a region that includes at least one local content appliance (CA) by a first client agent running at a local host of a first user, wherein the local CA is a storage device/host configured to store and maintain data of the first user;
uploading metadata of one or more files to a cloud storage while storing authoritative copies of the files and/or their parts on the at least one local CA in the region by the first client agent, wherein the files contain sensitive data of the first user;
retrieving the metadata of the files from the cloud storage and requesting access to the authoritative copies of the files and/or their parts directly from the local CA in the region based on the retrieved metadata by a second client agent running at a local host of a second user;
providing the authoritative copies of the files and/or their parts to the second client agent for a read or write operation if the second user has the permission to access the share and/or the region in which the files and/or their parts are maintained;
uploading changes to the authoritative copies of the parts and updated metadata of the files to the local CA and to the cloud storage, respectively, following a write operation to the files by the second user.

23. The method of claim 22, further comprising:
maintaining the authoritative copies of the files and/or their parts of the files and/or their parts only on the local CA in the region.

24. The method of claim 22, further comprising:
communicating between the CA and the cloud storage via a virtual private network (VPN) to optimize access, performance and security for local and cloud-based file synchronization and sharing.

25. The method of claim 22, further comprising:
Designating and establishing a plurality of regions to serve access requests to the files in the regions from different types of users.

26. The method of claim 22, further comprising:
identifying an IP address of the CA in the region on which the files and/its parts are to be stored, wherein the IP address is either an internal IP address if the CA is located within the same internal network as the local host of the first client agent behind a firewall or at a public IP address accessible by the first client agent over a network.

27. The method of claim 26, further comprising:
establishing a secured connection with the CA at the IP address directly, where all data transmitted over the secured connection is encrypted if the CA is located on a public network outside of the firewall of the internal network of the first client agent.

28. The method of claim 22, further comprising:
serving multiple client agents running on different local hosts by establishing separate secured connections with the client agents.

29. The method of claim 28, further comprising:
keeping the authoritative copies of files belonging to different client agents separately in their respective shares and/or regions so that one client agent may not access files in another share and/or region that belong to another client agent without access permission by that client agent.

30. The method of claim 22, further comprising:
organizing and storing the files in a plurality of shares in the region, wherein each share is configured to allow only its member users to access the files and/or their parts in the share.

31. The method of claim 30, further comprising:
specifying where each of the shares and the region should reside, either on the local CA or the cloud storage.

32. The method of claim 30, further comprising:
defining the access permission and restriction on either per-share basis or per-region basis, wherein each share and/or its region has a user access list associated with it, which includes a plurality of users and their access permissions in the form of (user, access permission).

33. The method of claim 32, further comprising:
submitting an access request to the first client agent directly so that the second user is included in the access list of the share and/or the region that contains the files the second user requests.

34. The method of claim 22, further comprising:
locking the authoritative copies of the files and/or their parts when the write operation is performed to the file and/or its parts via the second client agent and one or more parts of the file are revised or modified, where Under such scenario, on the CA is locked, meaning no update to the files and/or its parts is accepted before the second client agent is finished updating and uploading the revised file and its parts to the CA.

35. The method of claim 22, further comprising:
creating one or more events representing the changes made to the files and/or their parts during the write operation, wherein the changes are synchronized and updated to the authoritative copies of the files in the CA.

36. The method of claim 22, further comprising:
uploading updated metadata of the files to the cloud storage after the write operation, wherein the metadata reflects the latest changes made to the files and/or their parts.

37. The method of claim 22, further comprising:
notifying all other client agents accessing the files that the files and/or their parts have been updated and the updated metadata is available after the changes to the files and/or their parts have been uploaded and authorized as the new authoritative copies of the files.
